(19) United States
(12) Patent Application Publication
(10) Pub. No.: US 2005/0213326 A1
(43) Pub. Date: Sep. 29, 2005

(54) Modular lighting device

(76) Inventor: Eric Sanford, White Salmon, WA (US)

Correspondence Address: Eric Sanford, PO Box 1300, Hood River, OR, 97031, US

(21) Appl. No.: 11/093,750

(22) Filed: Mar. 29, 2005

Related U.S. Application Data
(60) Provisional application No. 60/557,577, filed on Mar. 29, 2004.
(60) Provisional application No. 60/557,578, filed on Mar. 29, 2004.

(51) Int. Cl. F21S 8/00

(52) U.S. Cl. 362/253

(57) ABSTRACT

The invention comprises a lighting unit having an integrated LED light source, solar panel, rechargeable battery and associated circuitry configured as a module. The module may be used for any application where a portable light source is desired and is easily incorporated into various devices. For example, the lid for a water container may be configured to accept the modular lighting unit. The modular lighting unit can be incorporated into other containers, such as a cooler, a roof top cargo carrier or other storage container, or into any other suitable device. Moreover, the modular lighting unit can be retrofitted into existing structures or enclosures, such as portable toilets, garden sheds and the like.

### CROSS REFERENCE TO RELATED APPLICATIONS

This invention claims priority of U.S. Provisionals 60/557,577 and 60/557,578, both filed Mar. 29, 2004.

### FIELD OF THE INVENTION

This invention relates to the field of portable, convenient lighting devices, preferably having a rechargeable power source that can be energized by solar power.

### BACKGROUND OF THE INVENTION

In a wide variety of situations, there exists a need for artificial lighting. For example, environmental conditions may call for additional lighting if the ambient light is insufficient to perform a desired activity. Also, containers and enclosures often are constructed from relatively opaque materials, making the interior of these structures dim even when there exists ambient light. Further, when these situations occur away from conventional sources of power, adequate lighting depends upon the user having a portable lighting device, such as a flashlight. As one can appreciate, many times a user will not have prepared for low light conditions and will not have a dedicated portable lighting device available.

Accordingly, there is a need for a modular lighting unit that can be integrated into a wide variety of devices and structures to increase the availability of auxiliary lighting.

There is also a need for modular lighting units that are relatively low in cost, weight and bulk.

This invention satisfies these and other needs.

### SUMMARY OF THE INVENTION

This invention comprises a modular lighting unit useful in a wide variety of applications. The lighting unit is an integrated LED light source, solar panel, rechargeable battery and associated circuitry configured as a module. The module may be used for any application where a portable light source is desired.

Further, the modular lighting unit is easily incorporated into various devices. Thus, devices having other primary uses can be configured to incorporate the modular lighting unit, providing enhanced convenience and utility. For example, the lid for a water container may be configured to accept the modular lighting unit. This allows a single device to have multiple uses or improved convenience. Similarly, the modular lighting unit can be incorporated into other containers, such as a cooler, a roof top cargo carrier or other storage container, or into any other suitable device. Moreover, the modular lighting unit can be retrofitted into existing structures or enclosures, such as portable toilets, garden sheds and the like.

Alternatively, the modular lighting unit can be incorporated into a device designed to enhance its use. For example, a holding and positioning device incorporating the modular lighting unit can be configured to position the unit to enhance its convenience. For example, the holding device can incorporate releasable attachments that allow the unit to be secured on a first surface to improve solar collection and then secured on a second surface for lighting use. In a preferred embodiment, such releasable attachments can comprise suction cups, but magnets, microhooks, adhesives and the like could also be used. Also preferably, the holding device can facilitate the positioning of the modular lighting unit to direct light to a desired area.

The modular lighting units of the invention may be used inside and outside, in automobiles, for personal safety or for emergency uses. As discussed above, the modular lighting units may be used alone, incorporated into articles having other uses or outfitted with devices that enhance the function for a particular use. The devices of the invention are especially suitable for backpackers, campers, boaters and other recreational users. The lighting system provides a safe, reliable, durable, long lasting, and energy-efficient device that produces useful visible light of desired wavelengths under a wide variety of outdoor and indoor circumstances and conditions.

In another embodiment of the invention, the lighting unit is configured to be integrated into an insulated container, for keeping materials relatively heated or cooled. Preferably, the lighting device is powered by a rechargeable power source that can be recharged by a solar panel. The lighting unit is an LED light source, solar panel, rechargeable power source and associated circuitry integrated into the insulated container.

The integrated lighting device is preferably configured so that the light source is internally oriented to cast illumination into the container when open. As such, the light source may be integrated into the lid of the container or into a container wall. In alternative embodiments, a light source is integrated into container with an external orientation so that it casts illumination on areas adjacent the container. Any combination of internal and external integrated lighting devices may be employed.

In additional embodiments, it is desirable to configure the integrated lighting device so that the rechargeable power source may be replaced with conventional batteries. Such embodiments are suitable when solar power is not sufficiently available to energize the rechargeable power source.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a top schematic view of a modular lighting unit, according to the invention;

FIG. 2 is a side schematic view of the modular lighting unit shown in FIG. 1;

FIG. 3 is a top schematic view of an alternate modular lighting unit, according to the invention;

FIG. 4 is a side schematic view of the modular lighting unit shown in FIG. 3;

FIG. 5 is a longitudinal cross sectional view of a modular lighting unit adapted in a beverage container; according to the invention;

FIG. 6 is an axial cross sectional view as shown in FIG. 5;

FIG. 7 is a top schematic view of the modular lighting unit shown in FIG. 5;

FIG. 8 is a side schematic view of the modular lighting unit shown in FIG. 5;

FIG. 9 is a top schematic view of another modular lighting unit, according to the invention;

FIG. 10 is a side schematic view of the modular lighting unit shown in FIG. 9;

FIG. 11 is a perspective view of a container having a modular lighting unit; according to the invention;

FIG. 12 is a perspective view of an enclosure having a modular lighting unit; according to the invention;

FIG. 13 is a perspective view of another container having a modular lighting unit; according to the invention;

FIG. 14 is a perspective view of yet another container having an integrated lighting unit; according to the invention; and

FIG. 15 is a perspective view of the container shown in FIG. 14, with the lid open.

### DETAILED DESCRIPTION OF THE INVENTION

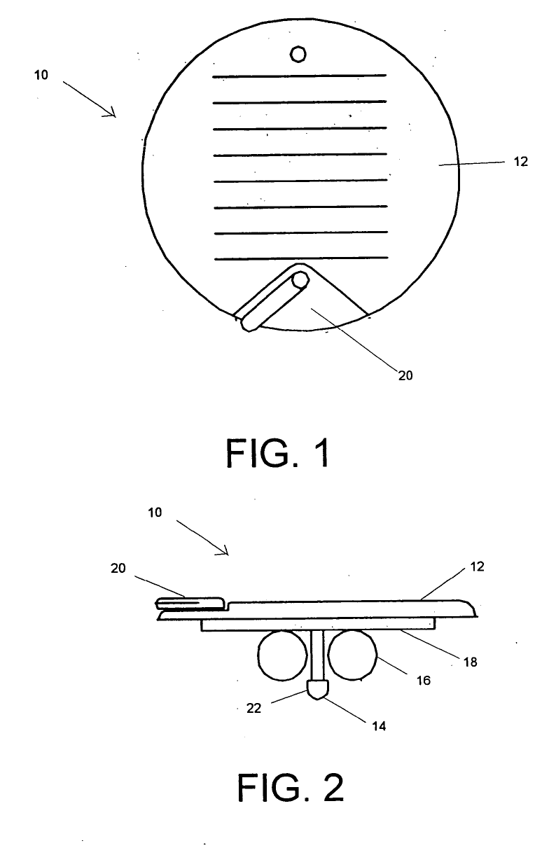

As shown in side view in FIG. 1 and top view in FIG. 2, a modular lighting unit 10 embodying features of the invention typically integrates solar panel 12, light-emitting diode (LED) light source 14, rechargeable power source 16 and circuitry 18. Circuitry 18 is used to deliver power from solar panel 12 to rechargeable power source 16 during periods when the device is exposed to sufficient light to generate electricity. Similarly, circuitry 18 also delivers power from rechargeable power source 16 to light source 14 when illumination is desired. In this embodiment, switch 20 can be used to turn light source 14 on and off as desired. Light source 14 may comprise one or more LEDs 22, depending upon the desired amount of light. As can be seen, modular light unit 10 is a compact, integrated device that is easily incorporated into a wide variety of applications. For situations presenting modest lighting needs, solar panel 12 and rechargeable power source 16 can be minimized to reduce the overall size of unit 10. Alternatively, solar panel 12 and rechargeable power source 16 can be correspondingly augmented to provide more robust lighting for demanding applications.

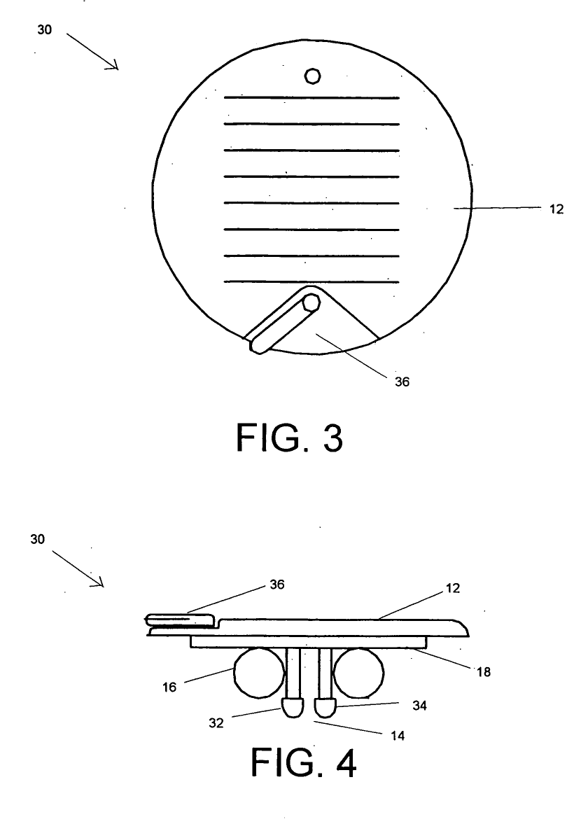

FIG. 3 shows a side view and FIG. 4 shows a top view of an alternative embodiment, comprising modular lighting unit 30, that also has solar panel 12, light source 14, rechargeable power source 16 and circuitry 18. Light source 14 comprises two LEDs 32 and 34 and multi-position switch 36 is configured to delivery power from rechargeable power source 16 to one or both LEDs 32 and 34.

In other embodiments, the switch can be configured to automatically operate LED 16. For example, the switch can be photosensitive, allowing for automatic operation of modular lighting unit 10 when the ambient light falls below a desired level. In embodiments where the switch is photosensitive, it may be desirable to position the switch on solar panel 12, so that the user may simply rest modular lighting unit 10 on solar panel 12 to shade the switch and activate light source 14.

A number of suitable LEDs may be used in the practice of the invention. In one embodiment, a high efficiency white LED is preferred, as this tends to provide the most natural and versatile light. An example of such LEDs is disclosed in U.S. Pat. No. 6,163,038 to Chen, et al., which is hereby incorporated in its entirety by reference. Alternatively, LEDs that produce other wavelengths of light can be used as desired. For example, a LED that emits a yellow light can provide a softer, less glaring illumination that may be preferable for aesthetic purposes. Also, a red LED may be desirable to preserve the user's night vision while still providing illumination.

One having skill in the art will recognize that the LEDs used in modular lighting units 10 or 30 could easily be made interchangeable to increase the versatility of the device. Further, two or more LEDs having different characteristics may be employed. For example, in the embodiment shown in FIG. 2, LED 32 could be a white LED and LED 34 could be a red LED. Switch 36 allows the user to select between the LEDs as desired. In other applications, switch 36 can be configured to operate either one or both LEDs 32 and 34, allowing the user to select between an efficient low power use mode and a higher light output mode. Alternatively, circuitry 18 can be adapted to provide more or less current to light source 14 to generate different light output depending upon the position of the switch.

The present invention employs a solar panel 12 that comprises a plurality of electrically connected photovoltaic cells to produce power to charge rechargeable power supply 16. Circuit 18 should conventionally include an in line blocking diode to prevent current leakage back to solar panel 12 when it is not charging and an in line voltage limiting circuit to prevent overcharging. It may also be desirable to provide a transformer and/or voltage regulator to increase the voltage and keep current steady during operation of the LED.

Rechargeable power supply 16 may comprise any suitable means for storing power from solar panel 12 and delivering that power to light source 14. For example, rechargeable batteries as are known in the art can be used. Such batteries may employ various chemistries to achieve the desired performance or maintain the desired economy. Example of rechargeable batteries that are currently preferred include nickel-cadmium, nickel metal hydride, lithium ion and others. Alternatively, capacitors may also be used in the practice of the invention. For example, capacitors up to about 100 farads are available at economical costs and larger storage capacities can be accomplished by adding additional capacitors.

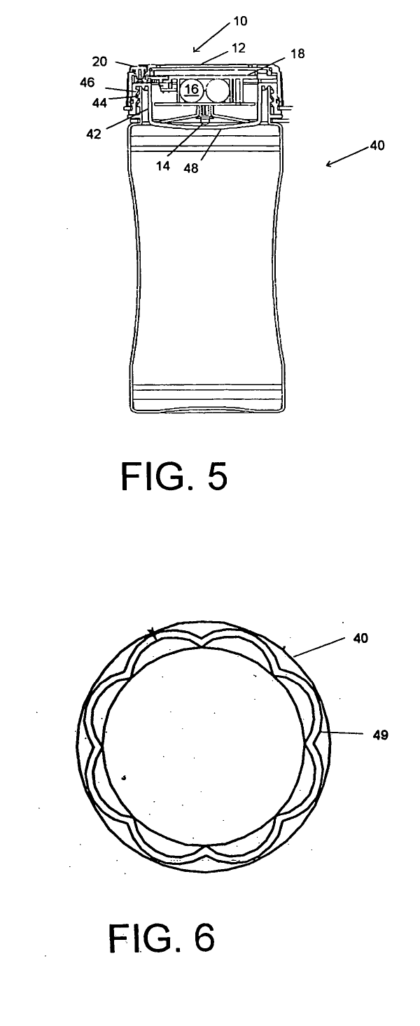

Turning now to FIG. 5, a container 40 of the invention is shown in cross-section that incorporates modular lighting unit 10 lid 42. Although reference is made to unit 10, modular lighting unit 30 could also be used. Lid 42 is removably attached to container 40 by way of threads 44 and 46 molded into the lid and container, respectively. Other means of attaching lid 42 to container 40, such as a snap-fit connection, may be used as desired. As shown, lid 42 comprises a translucent recess 48, preferably dome shaped, to receive modular lighting unit 10. Recess 48 is also sized so that modular lighting unit 10 can readily be secured to lid 42 around the periphery of unit 10. Preferably, lid 42 is a monolithic piece of material, so that no mechanical seal is required to isolate modular lighting unit 10 from the contents of container 40. As one of skill in the art will appreciate, this provides a very simple means of incorporating modular lighting unit 10 into container 40 without substantially altering the function of the container. Moreover, this avoids the risk of contaminating the container contents, damaging the components of lighting unit 10 and facilitates the cleaning of lid 42. In use, a user may carry or store container 40 throughout the day so that solar panel 12 is exposed to sunlight to charge rechargeable power source 16. Once dark, container 40 provides a convenient stand for employing lighting unit 10.

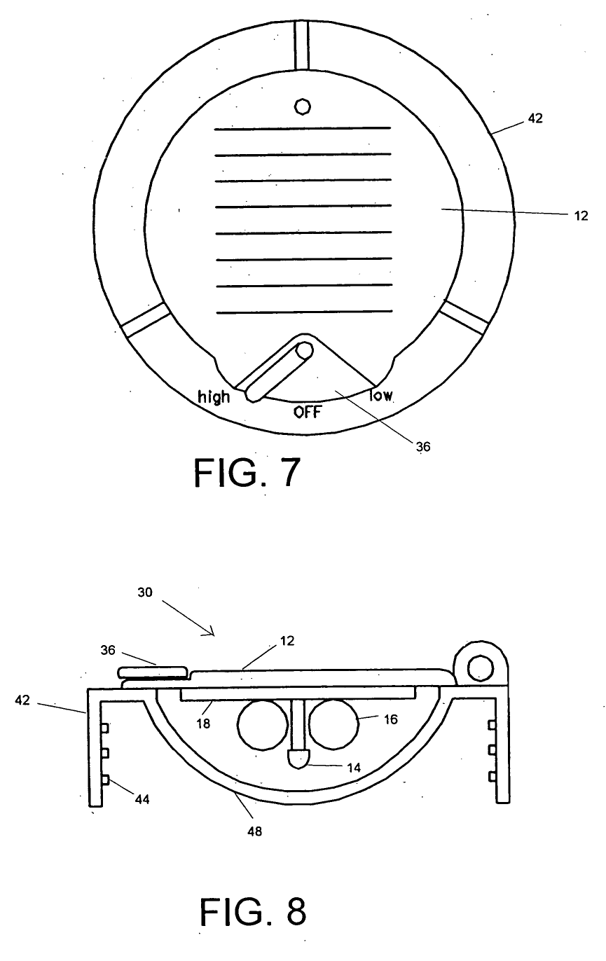

Container 40 is preferably molded from one of the well known translucent polymers, e.g., polyethylene, polypropylene, polycarbonate, etc. FIG. 6 is a cross section taken as shown in FIG. 5, that shows flutes, grooves or ridges 49 molded into the container to help function as a lens and improve light dispersion. These features are preferably situated on the outside of the container to facilitate cleaning. In some embodiments, lid 42 may also comprise a flange adapted to snap fit with the opening of container 40. This allows the lid to be reversed and secured to container 40 so that the light from LED is not diffused through the container. Although the lid 42 can be used as a light source by itself, attaching lid 42 to container 40 in this manner allows for hands-free use of more direct lighting. FIG. 7 shows a top view and FIG. 8 shows a side view of lid 42 incorporating modular lighting unit 30.

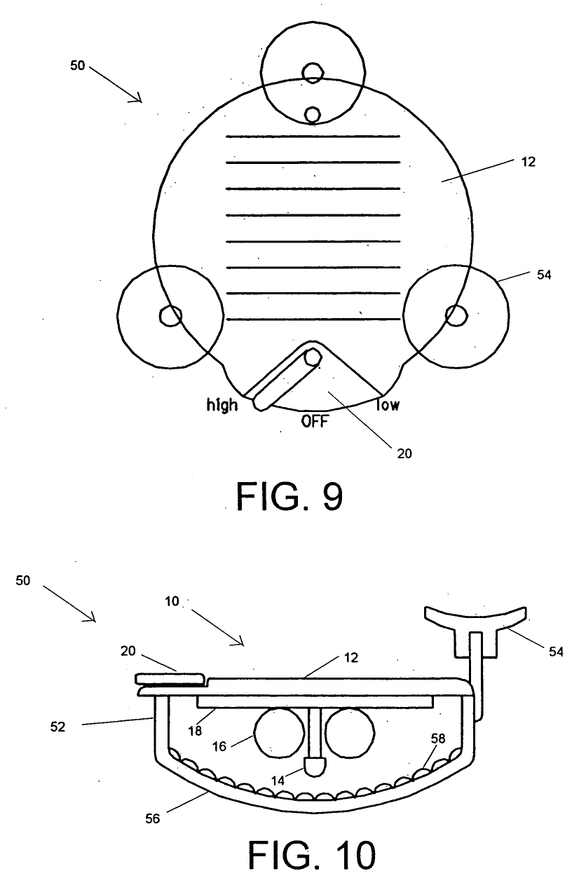

An alternate embodiment of the invention is shown in FIGS. 9 and 10, in top view and side view, respectively. Holding device 50 comprises housing 52 and releasable attachments 54. Housing 52 is sized to accommodate modular lighting unit 10, so that the periphery is readily secured. Although reference is made to unit 10, modular lighting unit 30 could also be used. A translucent recess 56 is configured to protect and contain the lighting unit, while transmitting light. Grooves or ridges 58 may be molded into recess 56 to function as a lens. Releasable attachments 54 generally provide a suitable means of securing holding device 50 to a surface. As shown, releasable attachments 54 are suction cups, but the use of magnets, adhesives, microhooks or the like is also suitable. As will be appreciated, holding device 50 is a convenient means of securing lighting unit 10 to a surface for either collecting solar energy to charge power source 16 or providing illumination from light source 14. Indeed, a particularly convenient means of using holding device 50 is to secure releasable attachments 54 to the inside of a window, allowing solar panel 12 to be exposed to exterior light. The lighting unit can then be used to provide illumination either in the same location or may be easily moved to another suitable surface.

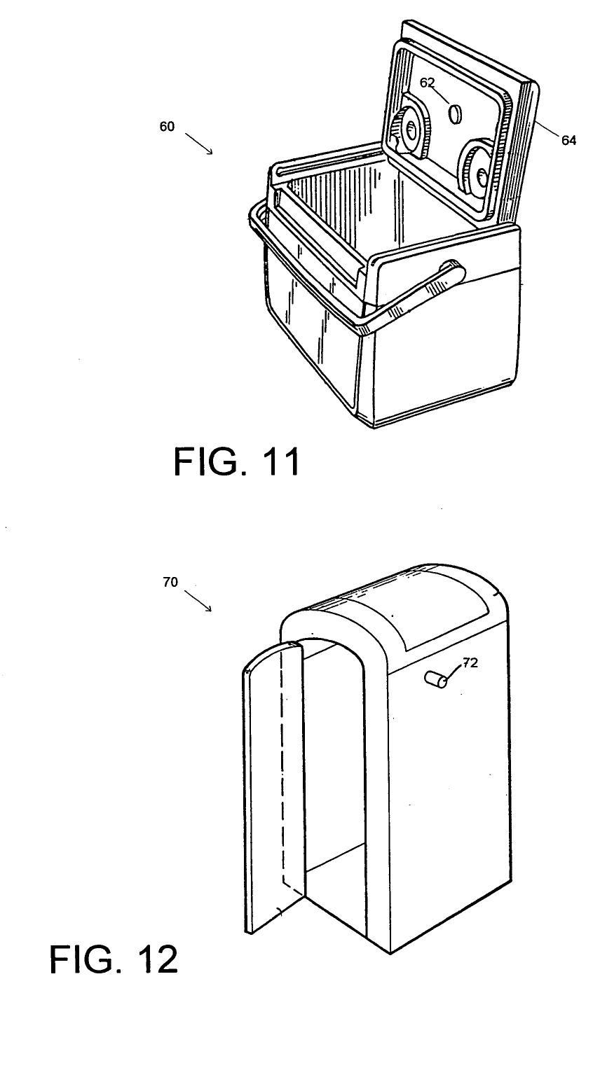

The modular lighting units of the invention can be configured to be easily retrofitted into existing containers, structures, enclosures and the like. For example, as shown in FIG. 11, an insulated container 60 is retrofitted with a modular lighting unit 62, that incorporates the features described above. As shown, modular lighting unit 62 is incorporated into lid 64 of container 60, bridging the surface so that the solar panel (not shown) is exposed to the exterior when lid 64 is closed. Modular lighting unit 62 can be positioned so as to direct light into container 60 or to an area adjacent. In the latter embodiment, container 60 primarily functions as a holder for modular lighting unit 62.

In another embodiment, FIG. 12 shows an existing enclosure 70 having an retrofitted modular lighting unit 72 incorporated into the wall or roof of the enclosure 70. Suitable enclosures include portable toilets, sheds or any other structure configured to accommodate one or more persons that does not have a dedicated light source. As above, modular lighting unit 72 can be positioned to supply light to the interior of enclosure 70, or could be positioned to cast light outwards to function as a beacon, for example.

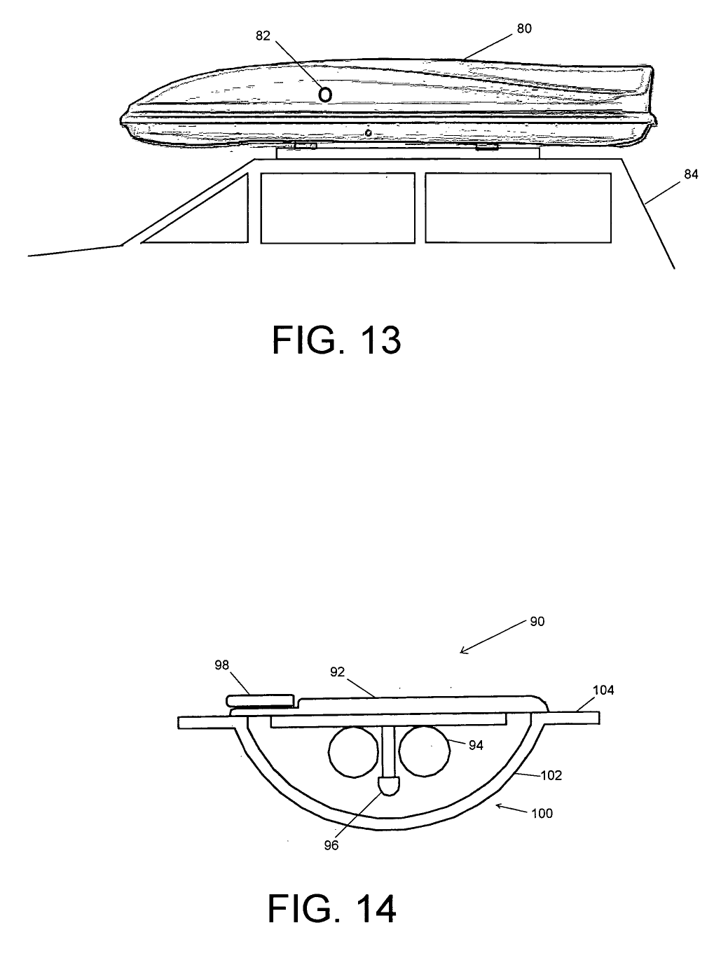

In yet another embodiment, FIG. 13 shows another structure suitable for retrofitting with a modular lighting unit of the invention. Container 80 is a conventional roof top cargo box secured to a vehicle 82. Modular lighting unit 84 is secured through a wall of container 80, bridging the surface and allowing the solar panel to be exposed during daylight hours and the LEDs to be positioned to cast light primarily within or adjacent container 80 as desired. As can be appreciated, container 80 can be any suitable structure, including a pickup truck canopy, a vehicle mounted toolbox, and similar structures.

FIG. 14 shows a modular lighting unit 90 configured to be retrofitted into an existing structure, enclosure or housing. As described above, modular lighting unit 90 generally comprises a solar panel 92 for charging batteries 94. LED 96 is connected to batteries 94, preferably through switch 98. As desired depending upon the application, switch 98 can comprise a mechanical switch, a motion-activated switch, e.g., mercury tilt switch, a photodetector switch, or other automatic switching device. Housing 100 generally comprises a transparent portion 102 shielding LED 96 and the associated electronics and a flange 104. By forming a hole or other aperture in a surface of the structure, such as a wall or roof, preferably having a diameter complimentary to transparent portion 102, modular lighting unit 90 bridges the surface so that solar panel 92 can be positioned to receive day light and LED 96 can be positioned to cast light within the enclosure. Flange 104 provides a convenient means to secure modular lighting unit 90 to the surface of the structure around the circumference of the formed hole. In general, the formed aperture is preferably sufficiently large to at least permit light from LED 96 to transmit into the interior of the retrofitted structure.

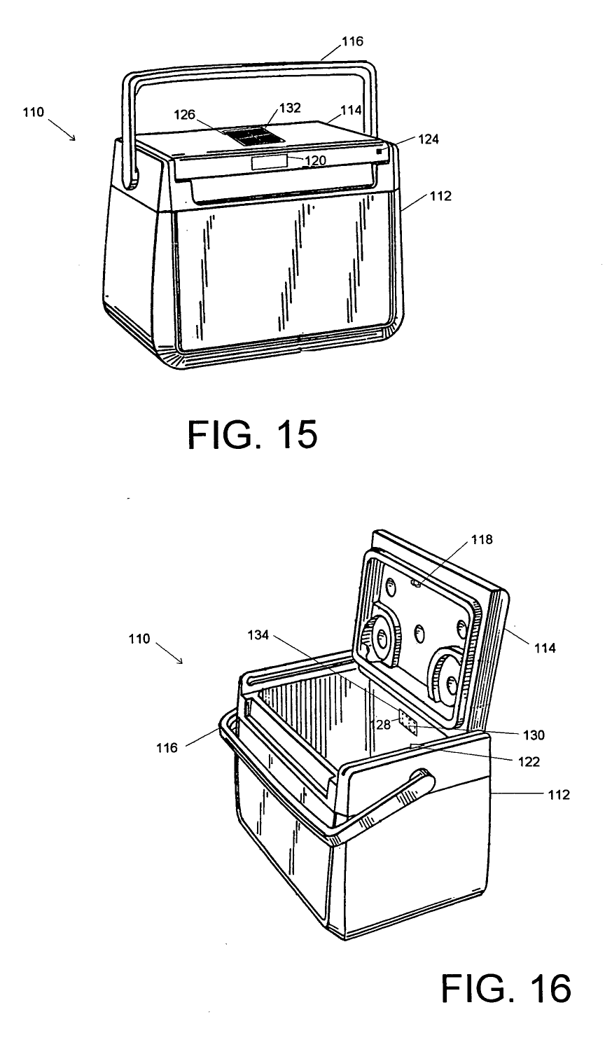

Turning now to FIGS. 15 and 16, show perspective views of an insulated container 110 having features of the invention in a closed and open configuration, respectively. The insulated container 110 generally comprises a body 112 and lid 114, hinged or not. Container may also comprise a handle 116 if desired. An integrated light comprises an internal light source 118 or an external light source 120, and either or both may be used. Preferably, internal light source 118 is controlled by switch 122 and external light source 120 by switch 124. Solar panel 126 is connected to rechargeable power source 128 through circuitry 130.

Light sources 118 and 120 may comprise one or more LEDs, as described above. For example, a white LED and a red LED could be used, with switch 122 or 124 controlling which LED is activated. In other applications, switch 122 or 124 can be configured to operate either one or more LEDs in light sources 118 or 120, allowing the user to select between an efficient low power use mode and a higher light output mode. Alternatively, circuitry 130 can be adapted to provide more or less current to light sources 118 or 120 to generate different light output depending upon the position of the switches. As described above, rechargeable power source 128 may comprise any suitable means for storing power from solar panel 126 and delivering that power to light source 118 or 120.

The present invention employs a solar panel 126 that comprises a plurality of electrically connected photovoltaic cells to produce power to charge rechargeable power source 128. Grid 132 can be used to protect solar panel 126 from damage. Circuitry 130 should conventionally include an in line blocking diode to prevent current leakage back to solar panel 126 when it is not charging and an in line voltage limiting circuit to prevent overcharging. It may also be desirable to provide a transformer and/or voltage regulator to increase the voltage and keep current steady during operation of the LED.

As one of skill in the art will recognize, switches 122 and 124 may be adapted to optimize the performance of the integrated lighting. For example, switch 122 can be configured to operate automatically as well as manually, so that internal light source 118 automatically turns on when lid 114 is opened, but can manually be turned off to conserve power if there is sufficient ambient light. Switch 124 can generally comprises a simple manual switch, allowing the user to activate external light source 120 whenever desired to provide illumination. However, a photosensitive switch could be used to automate the operation or a time delay switch could be used to automatically turn off the power after a given period of time to conserve power.

In one embodiment of the invention, a user can access rechargeable power source 128 through panel 134, allowing the user to replace power source 128 with conventional batteries. This permits operation of light sources 118 or 120, even in situations where there has been insufficient solar energy to power solar panel 126.

Without departing from the spirit and scope of this invention, one of ordinary skill can make various changes and modifications to the invention to adapt it to various usages and conditions. The modular lighting unit can be adapted to be included in a wide variety of devices. Alternatively, various other holding mechanisms can be adapted to position and utilize the modular lighting unit. Also, any number of configurations of insulated containers may be employed in the invention, both for heating and cooling applications. Similarly, the light sources, solar panel and rechargeable power source can be integrated into any convenient portion of the insulated container, including the lid, the sides, the handle, and the bottom, both on the exterior and interior of the container. As such, these changes and modifications are properly, equitably, and intended to be, within the full range of equivalence of the invention.

1. A modular lighting unit comprising an LED light source, a solar panel, a rechargeable battery and circuitry configured to transmit energy from the solar panel to the battery and to transmit energy from the battery to the LED, wherein the light source, the solar panel, the rechargeable battery and circuitry are configured as a modular unit.

2. The modular lighting unit of claim 1, further comprising a switch adapted to control the flow of energy from the battery to the LED.

3. The modular lighting unit of claim 2, wherein the switch is a manual switch.

4. The modular lighting unit of claim 2, wherein the switch is an automatic switch.

5. The modular lighting unit of claim 3, further comprising a second automatic switch that controls the flow of energy from the battery to the LED.

6. The modular lighting unit of claim 1, further comprising a beverage container, wherein the modular lighting unit is integrated into the beverage container.

7. The modular lighting unit of claim 6, wherein the modular lighting unit is integrated into a lid configured to releasably seal an opening in the beverage container.

8. The modular lighting unit of claim 6, wherein the lid is a monolithic structure and the modular lighting unit is configured to fit within a recess in the lid.

9. The modular lighting unit of claim 1, further comprising an enclosure configured accommodate a person having an interior and an exterior, wherein the modular lighting unit is configured to bridge a surface of the enclosure so that the solar panel is exposed to the exterior.

10. The modular lighting unit of claim 1, further comprising a container having an interior and an exterior, wherein the modular lighting unit is configured to bridge a surface of the container so that the solar panel is exposed to the exterior.

11. A method for supplying an existing structure with an auxiliary light source comprising the steps of:
providing a modular lighting unit having an LED light source, a solar panel, a rechargeable battery and circuitry configured to transmit energy from the solar panel to the battery and to transmit energy from the battery to the LED;
forming an aperture in a surface of the structure;
securing the modular lighting unit adjacent the aperture; and
operating the LED to cast light within the structure.

12. This invention comprises a modular lighting unit useful in a wide variety of applications. The lighting unit is an integrated LED light source, solar panel, rechargeable battery and associated circuitry configured as a module. The module may be used for any application where a portable light source is desired.
Further, the modular lighting unit is easily incorporated into various devices. Thus, devices having other primary uses can be configured to incorporate the modular lighting unit, providing enhanced convenience and utility. For example, the lid for a water container may be configured to accept the modular lighting unit. This allows a single device to have multiple uses or improved convenience. Similarly, the modular lighting unit can be incorporated into other containers, such as a cooler, a roof top cargo carrier or other storage container, or into any other suitable device. Moreover, the modular lighting unit can be retrofitted into existing structures or enclosures, such as portable toilets, garden sheds and the like.
